(19) United States
(12) Patent Application Publication
(10) Pub. No.: US 2023/0192187 A1
(43) Pub. Date: Jun. 22, 2023

(54) CRAWLER-TYPE WORK MACHINE

(71) Applicant: KOMATSU LTD., Tokyo (JP)

(72) Inventors: Takeshi YOSHIKAWA, Tokyo (JP); Naoya AKIYAMA, Tokyo (JP); Hiroaki TAKESHIMA, Tokyo (JP); Akane HAYASHI, Tokyo (JP); Yoshitaka KIKUCHI, Tokyo (JP)

(21) Appl. No.: 17/918,195

(22) PCT Filed: Jun. 15, 2021
(86) PCT No.: PCT/JP2021/022721

§ 371 Date: Oct. 11, 2022

(30) Foreign Application Priority Data
Jul. 30, 2020 (JP) 2020-129003

(51) Int. Cl. B62D 11/08; B62D 11/10; F16H 1/28; B60K 17/16; E02F 3/76

(52) U.S. Cl. CPC B62D 11/08; B62D 11/10; F16H 1/28; B60K 17/16; E02F 3/76

(57) ABSTRACT

A bulldozer has a left planetary gear mechanism, a left steering clutch, and a first clutch gear. The left planetary gear mechanism is disposed between an input shaft and a left output shaft. The left steering clutch switches between transmitting and blocking a rotational force from the input shaft to the left output shaft by the left planetary gear mechanism. The first clutch gear is attached to the left steering clutch. The left steering clutch can is configured to be engaged or disengaged with a left sun gear. The first clutch gear is fixed in an unrotatable manner.

### CROSS-REFERENCE TO RELATED APPLICATIONS

This application is a U.S. National stage application of International Application No. PCT/JP2021/022721, filed on Jun. 15, 2021. This U.S. National stage application claims priority under 35 U.S.C. § 119(a) to Japanese Patent Application No. 2020-129003, filed in Japan on Jul. 30, 2020, the entire contents of which are hereby incorporated herein by reference.

### TECHNICAL FIELD

The present disclosure relates to a crawler-type work machine.

### BACKGROUND INFORMATION

Conventionally, a crawler-type work machine (for example, a bulldozer, etc.) is provided with left and right steering brakes that brake left and right output shafts coupled to left and right drive wheels, and a steering clutch that is attached to an input shaft disposed between the left and right output shafts and that transmits or blocks a rotational force from the input shaft to the output shafts (for example, see Japanese Patent Laid-open No. 2013-091491).

The crawler-type work machine is able to turn to the left or right by controlling the hydraulic pressure of the steering clutch and the steering brakes. SUMMARY

### Problem to be Resolved

However, in the crawler-type work machine described in Japanese Patent Laid-open No. 2013-091491, a large torque passes through the steering clutch because the steering clutch is attached directly to the input shaft. As a result, the steering clutch needs to have high stiffness and the steering clutch cannot be made compact.

An object of the present disclosure is to provide a crawler-type work machine in which the steering clutch can be made compact.

A crawler-type work machine according to one aspect of the present disclosure has a planetary gear mechanism, a steering clutch, and a clutch gear. The planetary gear mechanism is disposed between an input shaft and an output shaft. The steering clutch is configured to switch between transmitting and blocking a rotational force from the input shaft to the output shaft by the planetary gear mechanism. The clutch gear is attached to the steering clutch. The planetary gear mechanism has a ring gear coupled to the input shaft, a sun gear rotatably attached to the input shaft, a planetary gear disposed between the ring gear and the sun gear, and a carrier coupled to the planetary gear and the output shaft. The steering clutch can be engaged or disengaged with the sun gear. The clutch gear is fixed in an unrotatable manner.

According to the crawler-type work machine according to the present disclosure, the steering clutch can be made compact.

### BRIEF DESCRIPTION OF DRAWINGS

FIG. 1 is a perspective view of a bulldozer that is an example of a crawler-type work machine.

FIG. 2 is a cross-sectional configuration drawing of a power transmission system of the bulldozer.

FIG. 3 is an outline system configuration drawing of the power transmission system of the bulldozer including a fixing member.

FIG. 4 is an outline system configuration drawing of the power transmission system of the bulldozer including a turning motor.

FIG. 5 is a cross-sectional configuration drawing of the power transmission system of the bulldozer.

### DESCRIPTION OF EMBODIMENTS

### (Configuration of Bulldozer 1)

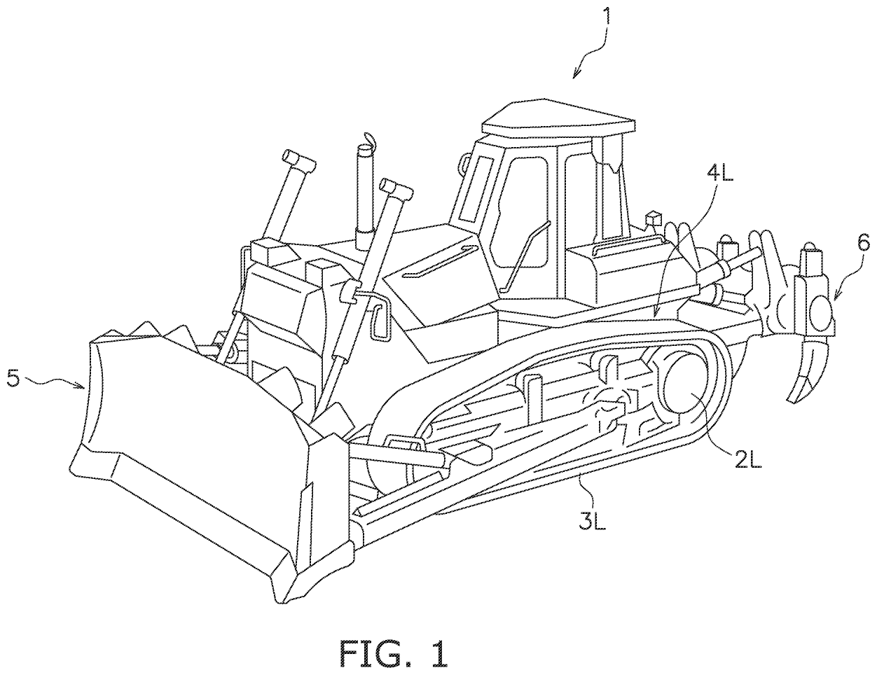

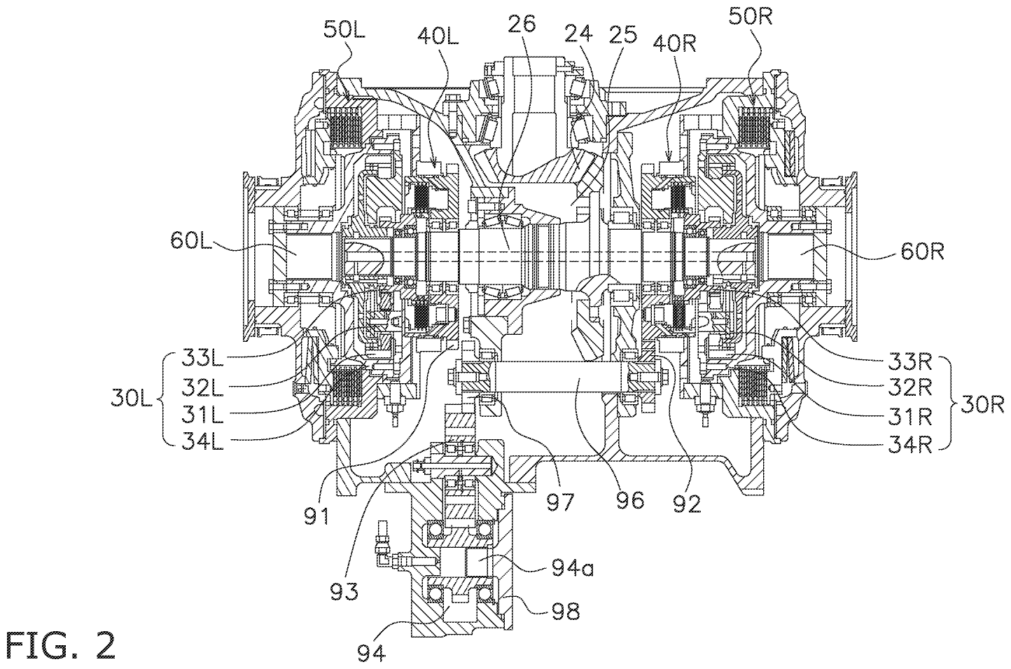

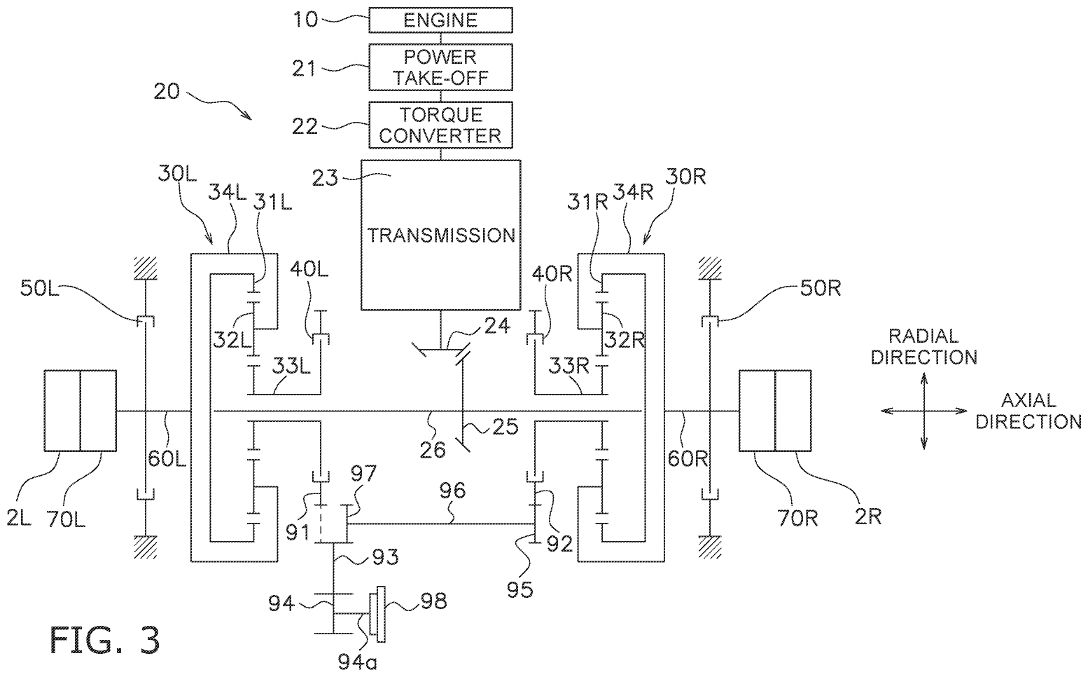

FIG. 1 is a perspective view of a bulldozer 1 that is an example of the crawler-type work machine. FIG. 2 is a cross-sectional configuration drawing of a power transmission system of the bulldozer 1. FIG. 3 is an outline system configuration diagram of the power transmission system of the bulldozer 1.

The bulldozer 1 is equipped with left and right travel devices 4L, 4R that respectively have left and right sprockets 2L, 2R and left and right crawler belts 3L, 3R; a blade 5 provided at the vehicle front portion; and a ripper device 6 provided at the vehicle rear portion.

The bulldozer 1 is able to do work such as pushing earth with the blade 5 and work such as crushing and excavating with the ripper device 6.

The bulldozer 1 includes an engine 10, a power transmission device 20, left and right planetary gear mechanisms 30L, 30R, left and right steering clutches 40L, 40R, left and right steering brakes 50L, 50R, left and right output shafts 60L, 60R, and left and right final drive gears 70L, 70R.

The power transmission device 20 transmits power from the engine 10 to the left and right planetary gear mechanisms 30L, 30R. The power transmission device 20 includes a power take-off device 21, a torque converter 22, a transmission 23, a pinion 24, a bevel gear 25, and an input shaft 26.

The power transmission device 21 transmits power from the engine 10 to the torque converter 22. The torque converter 22 transmits the power of the engine 10 transmitted by the power take-off device 21 to the transmission 23 by means of a fluid. The transmission 23 changes the speed of the rotation motion transmitted from the torque converter 22. The transmission 23 is able to switch between forward travel and reverse travel. The transmission 23 is coupled to the pinion 24. The power from the transmission 23 is transmitted through the pinion 24 and the bevel gear 25 to the input shaft 26.

The left and right planetary gear mechanisms 30L, 30R are disposed between the input shaft 26 and the left and right output shafts 60L, 60R. The left and right planetary gear mechanisms 30L, 30R respectively have left and right ring gears 31L, 31R, left and right planetary gears 32L, 32R, left and right sun gears 33L, 33R, and left and right carriers 34L, 34R.

The left and right ring gears 31L, 31R are coupled to the input shaft 26. The left and right planetary gears 32L, 32R are respectively disposed inside the left and right ring gears 31L, 31R in a radial direction perpendicular to the center axis of the input shaft 26. The left and right planetary gears 32L, 32R respectively mesh with the left and right ring gears 31L, 31R and the left and right sun gears 33L, 33R. The left and right sun gears 33L, 33R are rotatably attached to the input shaft 26. The left and right sun gears 33L, 33R are respectively disposed inside the left and right planetary gears 32L, 32R in the radial direction. The left and right sun gears 33L, 33R are respectively coupled to the left and right steering clutches 40L, 40R. The left and right carriers 34L, 34R are respectively coupled to the left and right planetary gears 32L, 32R and the left and right output shafts 60L, 60R.

The left and right steering clutches 40L, 40R are wet multiplate clutches that can be respectively engaged or disengaged with the left and right sun gears 33L, 33R. The left and right steering clutches 40L, 40R switch between transmitting and blocking the rotation from the input shaft 26 to the respective left and right output shafts 60L, 60R by means of the respective left and right planetary gear mechanisms 30L, 30R.

Specifically, when the left steering clutch 40L is coupled and the left sun gear 33L is directly coupled with a first clutch gear 91, the first clutch gear 91 cannot rotate (see below) and the left sun gear 33L also cannot rotate. As a result, the rotation of the input shaft 26 is transmitted through the left ring gear 31L, the left planetary gear 32L, and the left carrier 34L to the left output shaft 60L. When the left steering clutch 40L is disengaged and the left sun gear 33L enters a freely rotating state, the rotation from the input shaft 26 to the left output shaft 60L is blocked. Similarly, transmitting or blocking the rotation from the input shaft 26 to the right output shaft 60R is switched in accordance with the engagement or disengagement of the right steering clutch 40R.

The first clutch gear 91 is attached to the left steering clutch 40L. The first clutch gear 91 is fixed in an unrotatable manner. The first clutch gear 91 is coupled directly to an idler gear 93.

In addition, a second clutch gear 92 is attached to the right steering clutch 40R. The second clutch gear 92 is fixed in an unrotatable manner. The second clutch gear 92 is coupled indirectly to the idler gear 93 through a first transfer gear 95, an auxiliary shaft 96, and a second transfer gear 97.

The idler gear 93 is coupled to a pinion gear 94. A pinion shaft 94a is coupled to the pinion gear 94. The pinion shaft 94a is fixed in an unrotatable manner by a fixing member 98.

In this way, the pinion shaft 94a is fixed in an unrotatable manner whereby the pinion gear 94 is fixed in an unrotatable manner in the present embodiment. The pinion gear 94 is fixed in an unrotatable manner whereby the first clutch gear 91 and the second clutch gear 92 are both fixed in an unrotatable manner.

Therefore, the rotational force from the left and right steering clutches 40L, 40R is not applied to the left and right sun gears 33L, 33R. Accordingly, in the configuration illustrated in FIG. 3, the first clutch gear 91, the second clutch gear 92, the idler gear 93, the pinion gear 94, the first transfer gear 95, the auxiliary shaft 96, and the second transfer gear 97 only have the function of braking (fixing) the left and right sun gears 33L, 33R when the left and right steering clutches 40L, 40R are engaged.

The fixing member 98 is detachably fixed to an unillustrated housing. When the fixing member 98 is removed from the housing, the fixing member 98 can be removed from the pinion gear 94. As a result, the fixing of the pinion gear 94 by the fixing member 98 can be released.

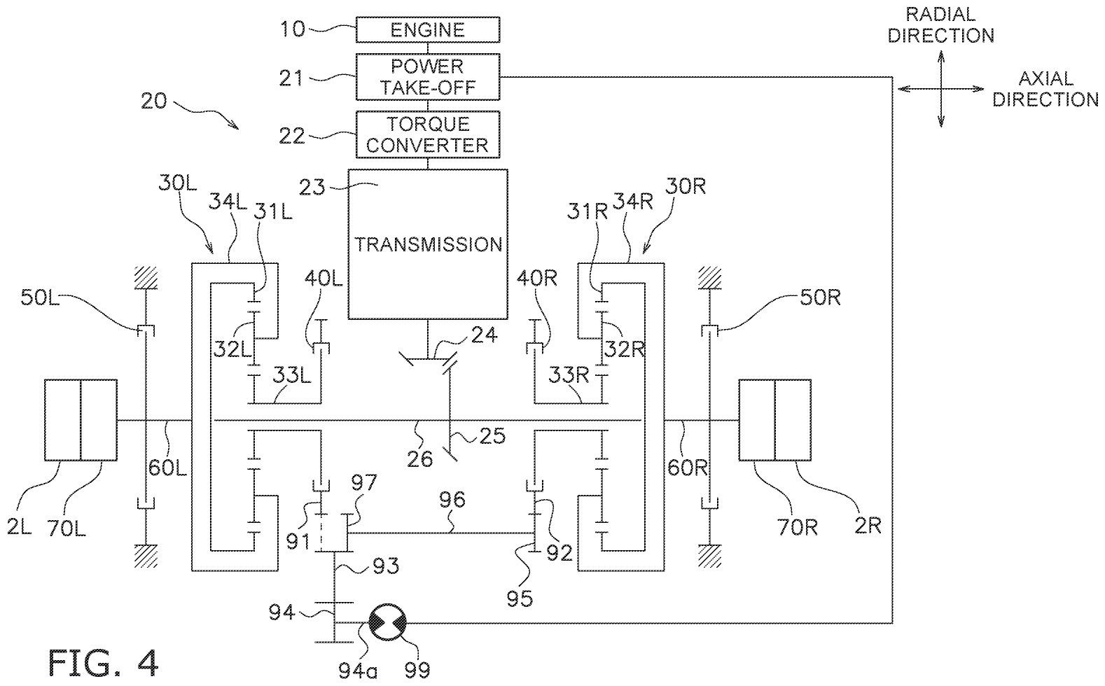

When the fixing of the pinion gear 94 by the fixing member 98 is released, a turning motor 99 can be attached to the pinion shaft 94a as illustrated in FIG. 4. The turning motor 99 is a hydraulic pump driven by power from the engine 10 transmitted from the power take-off device 21 in the present embodiment.

In this way, when the fixing of the pinion shaft 94a is released, the first clutch gear 91 and the second clutch gear 92 are able to rotate and the rotational force of the turning motor 99 can be applied to the left and right sun gears 33L, 33R through the left and right steering clutches 40L, 40R.

Specifically, when the left and right steering clutches 40L, 40R are engaged and the rotational force of the motor is transmitted to the left and right sun gears 33L, 33R through the left and right steering clutches 40L, 40R, the left and right sun gears 33L, 33R rotate in the opposite directions at the same rotation speed. Consequently, a rotation speed difference is generated in the left and right output shafts 60L, 60R and the bulldozer 1 is able to turn gently to the left or right.

As indicated above, when the turning motor 99 is attached to the pinion shaft 94a, the first clutch gear 91, the second clutch gear 92, the idler gear 93, the pinion gear 94, the first transfer gear 95, the auxiliary shaft 96, and the second transfer gear 97 function as transmitting members for transmitting the rotational force of the turning motor 99 to the left and right sun gears 33L, 33R.

The left and right steering brakes 50L, 50R respectively brake the rotation of the left and right output shafts 60L, 60R. The left and right steering brakes 50L, 50R are wet multiplate clutches that can be respectively engaged or disengaged with the left and right output shafts 60L, 60R.

When the left steering brake 50L is engaged, braking is applied to the rotation of the left output shaft 60L. As a result, the rotation of the left final drive gear 70L coupled to the left sprocket 2L is reduced. When the right steering brake 50R is engaged, braking is applied to the rotation of the right output shaft 60R. As a result, the rotation of the right final drive gear 70R coupled to the right sprocket 2R is reduced.

The bulldozer 1 comprises the left planetary gear mechanism 30L, the left steering clutch 40L, and the first clutch gear 91. The left planetary gear mechanism 30L is disposed between the input shaft 26 and the left output shaft 60L. The left steering clutch 40L switches between transmitting and blocking the rotational force from the input shaft 26 to the left output shaft 60L by means of the left planetary gear mechanism 30L. The first clutch gear 91 is attached to the left steering clutch 40L. The left steering clutch 40L can be engaged or disengaged with the left sun gear 33L. The first clutch gear 91 is fixed in an unrotatable manner.

In this way, the torque passing through the left steering clutch 40L can be reduced because the left steering clutch 40L is attached to the left sun gear 33L. Therefore, there is no need to excessively increase the stiffness of the left steering clutch 40L and the left steering clutch 40L can be made compact. This effect can be achieved in the same way for the right steering clutch 40R.

Additionally, because the first clutch gear 91 is fixed in an unrotatable manner, the left sun gear 33L can be easily braked, and when the fixing of the first clutch gear 91 is released, the configuration can be easily modified to a configuration for being able to transmit the rotational force to the left sun gear 33L through the left steering clutch 40L. This effect can also be achieved for the second clutch gear 92.

The present disclosure is not limited to the above embodiment and various changes and modifications may be made without departing from the spirit of the disclosure.

While the pinion shaft 94a is fixed in an unrotatable manner whereby the pinion gear 94 is fixed in an unrotatable manner in the present embodiment, the method for fixing the pinion gear 94 is not limited thereto. For example, the teeth of the pinion gear 94 can be fixed directly.

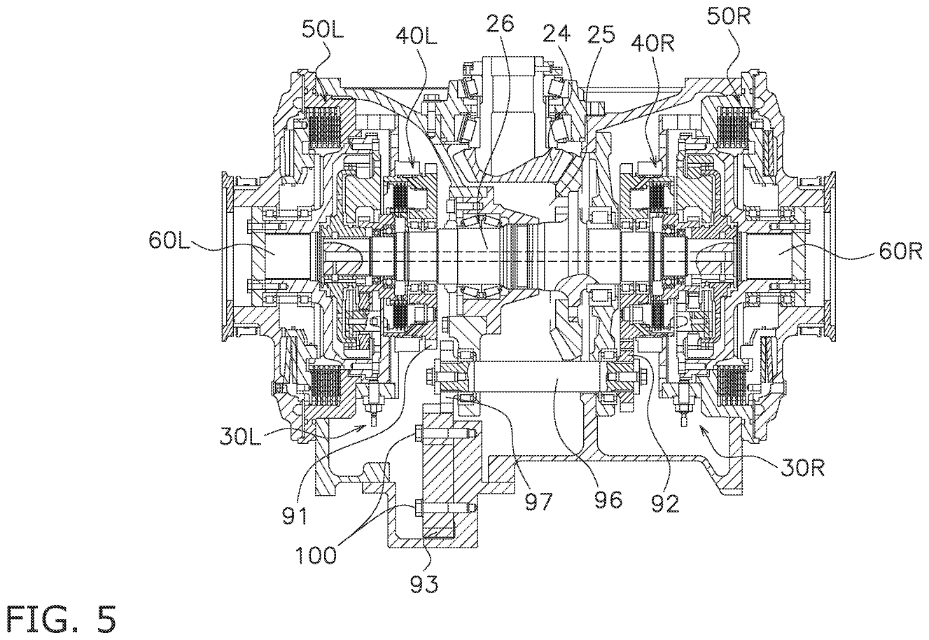

While the first clutch gear 91 and the second clutch gear 92 are coupled to the pinion gear 94 through the idler gear 93 in the above embodiment, the idler gear 93 can be omitted as illustrated in FIG. 5. In this case, the idler gear 93 is fixed in an unrotatable manner instead of the pinion gear 94 whereby the first clutch gear 91 and the second clutch gear 92 are both fixed in an unrotatable manner. In the example illustrated in FIG. 5, while the idler gear 93 is fixed in an unrotatable manner by using a plurality of idler gear bolts 100 as fixing members, the number of the idler gear bolts 100 is not limited and may be one or more.

While the pinion gear 94 is fixed in an unrotatable manner whereby the first clutch gear 91 and the second clutch gear 92 are both fixed in an unrotatable manner in the above embodiment, the present disclosure is not limited thereto. For example, even if the pinion gear 94 is present, the idler gear 93 can be fixed in an unrotatable manner instead of the pinion gear 94 whereby the first clutch gear 91 and the second clutch gear 92 are both fixed in an unrotatable manner. In this case, the idler gear bolts 100 illustrated in FIG. 5 can be used for fixing the idler gear 93.

1. A crawler-type work machine comprising:
a planetary gear mechanism disposed between an input shaft and an output shaft;
a steering clutch configured to switch between transmitting and blocking a rotational force from the input shaft to the output shaft by the planetary gear mechanism; and
a clutch gear attached to the steering clutch,
the planetary gear mechanism including
a ring gear coupled to the input shaft,
a sun gear rotatably attached to the input shaft,
a planetary gear disposed between the ring gear and the sun gear, and
a carrier coupled to the planetary gear and the output shaft,
the steering clutch being configured to be engaged or disengaged with the sun gear, and
the clutch gear being fixed in an unrotatable manner.

2. The crawler-type work machine according to claim 1, further comprising
an idler gear coupled to the clutch gear, and
a pinion gear coupled to the idler gear,
at least one of the idler gear and the pinion gear being fixed in an unrotatable manner whereby the clutch gear is fixed in an unrotatable manner.

3. The crawler-type work machine according to claim 1, further comprising
a pinion gear coupled to the clutch gear,
the pinion gear being fixed in an unrotatable manner whereby the clutch gear is fixed in an unrotatable manner.

4. The crawler-type work machine according to claim 2, further comprising
a pinion shaft coupled to the pinion gear,
the pinion shaft being fixed in an unrotatable manner whereby the clutch gear is fixed in an unrotatable manner.

5. The crawler-type work machine according to claim 4, wherein
when the fixing of the pinion shaft is removed, a turning motor is configured to be attached to the pinion shaft.

6. The crawler-type work machine according to claim 3, further comprising
a pinion shaft coupled to the pinion gear,
the pinion shaft being fixed in an unrotatable manner whereby the clutch gear is fixed in an unrotatable manner.

7. The crawler-type work machine according to claim 6, wherein
when the fixing of the pinion shaft is removed, a turning motor is configured to be attached to the pinion shaft.
